(19) United States
(12) Patent Application Publication
(10) Pub. No.: US 2026/0118663 A1
(43) Pub. Date: Apr. 30, 2026

(54) SYSTEMS AND METHODS FOR A STIMULUS-BASED ANTI-GLARE SURFACE

(71) Applicant: Toyota Motor Engineering & Manufacturing North America, Inc., Plano, TX (US)

(72) Inventors: Ozgun Kilic AFSAR, Cambridge, MA (US); Koray Benli, Ann Arbor, MI (US); Yuyang Song, Ann Arbor, MI (US); Shinnosuke Shimokawa, Ann Arbor, MI (US); Umesh Gandhi, Farmington Hills, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/933,359

(22) Filed: Oct. 31, 2024

(51) Int. Cl. G02B 27/00; B60K 35/40; G02F 1/13

(52) U.S. Cl. CPC G02B 27/0018; B60K 35/415; B60K 35/425; G02F 1/1313

(57) ABSTRACT

A method, computer program product, and self-reversing material for incorporating a material into an interior portion of a vehicle, wherein the material is a self-reversing material. The material may be exposed to a stimulus, wherein the material has a first shape prior to being exposed to the stimulus. The first shape of the material may be altered to a second shape based upon, at least in part, exposing the material to the stimulus. The stimulus may be removed from the material. The second shape may be altered back to the first shape based upon, at least in part, removing the stimulus from the material.

### BACKGROUND

Vehicle dashboards are generally composed of class A surfaces (i.e., continuous surfaces having curvature and tangency alignment) for aesthetical purposes. While ensuring good aesthetic quality of reflections under different ambient lights, these dashboards often disturb and impair the driver's forward vision when exposed to direct sunlight. Moreover, when a part of a reflective dashboard is reflected into the windshield, the veiling glare (also known as a “ghost images” effect) can occur, decreasing the visibility of the objects ahead on the road, causing a safety hazard.

### SUMMARY

In one example implementation, a method, performed by one or more computing devices, may include but is not limited to incorporating a material into an interior portion of a vehicle, wherein the material is a self-reversing material. The material may be exposed to a stimulus, wherein the material has a first shape prior to being exposed to the stimulus. The first shape of the material may be altered to a second shape based upon, at least in part, exposing the material to the stimulus. The stimulus may be removed from the material. The second shape may be altered back to the first shape based upon, at least in part, removing the stimulus from the material.

One or more of the following example features may be included. The material may include a plurality of liquid crystal elastomer unit cells. The stimulus may be ultraviolet light. The stimulus may be heat. Incorporating the material into the interior portion of the vehicle may include incorporating the material into a dashboard of the vehicle. Incorporating the material into the interior portion of the vehicle may include embedding the material on a side of a fabric. The fabric may be a four-way stretchable fabric.

In another example implementation, a self-reversing material may include but is not limited to a material incorporated into an interior portion of a vehicle, wherein the material is a self-reversing material. The material may have a first shape prior to being exposed to a stimulus. The first shape of the material may be altered to a second shape based upon, at least in part, exposure of the material to the stimulus. The second shape may be altered back to the first shape based upon, at least in part, removing the stimulus from the material.

One or more of the following example features may be included. The material may include a plurality of liquid crystal elastomer unit cells. The stimulus may be ultraviolet light. The stimulus may be heat. Incorporating the material into the interior portion of the vehicle may include incorporating the material into a dashboard of the vehicle. Incorporating the material into the interior portion of the vehicle may include embedding the material on a side of a fabric. The fabric may be a four-way stretchable fabric.

In another example implementation, a computer program product may reside on a computer readable storage medium having a plurality of instructions stored thereon which, when executed across one or more processors, may cause at least a portion of the one or more processors to perform operations that may include but are not limited to incorporating a material into an interior portion of a vehicle, wherein the material is a self-reversing material. The material may be exposed to a stimulus, wherein the material has a first shape prior to being exposed to the stimulus. The first shape of the material may be altered to a second shape based upon, at least in part, exposing the material to the stimulus. The stimulus may be removed from the material. The second shape may be altered back to the first shape based upon, at least in part, removing the stimulus from the material.

One or more of the following example features may be included. The material may include a plurality of liquid crystal elastomer unit cells. The stimulus may be ultraviolet light. The stimulus may be heat. Incorporating the material into the interior portion of the vehicle may include incorporating the material into a dashboard of the vehicle. Incorporating the material into the interior portion of the vehicle may include embedding the material on a side of a fabric. The fabric may be a four-way stretchable fabric.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of an anti-glare (AG) process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of an AG process according to one or more example implementations of the disclosure;

FIG. 4 is an example diagrammatic view of a vehicle dashboard prior to being exposed to a stimulus according to one or more example implementations of the disclosure; and

FIG. 5 is an example diagrammatic view of a self-reversing material according to one or more example implementations of the disclosure; and

FIG. 6 is an example diagrammatic view of a vehicle dashboard after being exposed to a stimulus according to one or more example implementations of the disclosure.

Like reference symbols in the various drawings may indicate like elements.

### DESCRIPTION

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

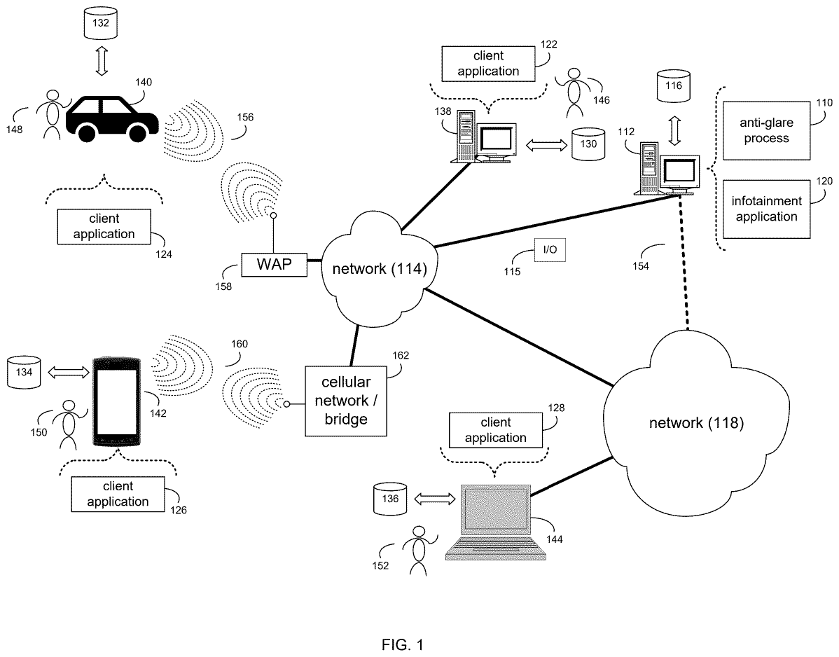

Referring now to the example implementation of FIG. 1, there is shown AG process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an anti-glare (AG) process, such as AG process 110 of FIG. 1, may incorporate a material into an interior portion of a vehicle, wherein the material is a self-reversing material. The material may be exposed to a stimulus, wherein the material has a first shape prior to being exposed to the stimulus. The first shape of the material may be altered to a second shape based upon, at least in part, exposing the material to the stimulus. The stimulus may be removed from the material. The second shape may be altered back to the first shape based upon, at least in part, removing the stimulus from the material.

In some implementations, the instruction sets and subroutines of AG process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, AG process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a infotainment application (e.g., infotainment application 120), examples of which may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a climate control application, a navigation application, a multimedia application, a connectivity application, a voice control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc., a virtual reality (VR) application, an extended reality (XR) application also known as mixed reality (MR), an augmented reality (AR) application, a telephony application, a voice-over-IP application, a video-over-IP application, an Instant Messaging (IM)/“chat” application, an interactive voice response (IVR) application, a short messaging service (SMS)/multimedia messaging service (MMS) application, or other application that allows for virtual and/or remote communication. In some implementations, AG process 110 and/or infotainment application 120 may be accessed via one or more of client applications 122, 124, 126, 128. In some implementations, AG process 110 may be a standalone application, or may be an applet/application/script/extension that may interact with and/or be executed within infotainment application 120, a component of infotainment application 120, and/or one or more of client applications 122, 124, 126, 128. In some implementations, infotainment application 120 may be a standalone application, or may be an applet/application/script/extension that may interact with and/or be executed within AG process 110, a component of AG process 110, and/or one or more of client applications 122, 124, 126, 128. In some implementations, one or more of client applications 122, 124, 126, 128 may be a standalone application, or may be an applet/application/script / extension that may interact with and/or be executed within and/or be a component of AG process 110 and/or infotainment application 120. Examples of client applications 122, 124, 126, 128 may include, but are not limited to, e.g., an automatic speech recognition (ASR) application (e.g., modeling, transcription, etc.), a natural language understanding (NLU)/natural language processing (NLP) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a climate control application, a navigation application, a multimedia application, a connectivity application, a voice control application, a smartphone integration application, a touchscreen interface application, an internet and “apps” application, a rear-seat entertainment application, or other application that allows for combining information and/or entertainment with optional screens and/or audio for such things as navigation, multimedia, connectivity, voice control, smartphone integration, touchscreen interface, internet and apps, rear-seat entertainment, etc., a virtual reality (VR) application, an extended reality (XR) application also known as mixed reality (MR), an augmented reality (AR) application, a telephony application, a voice-over-IP application, a video-over-IP application, an Instant Messaging (IM)/“chat” application, an interactive voice response (IVR) application, a short messaging service (SMS)/multimedia messaging service (MMS) application, or other application that allows for virtual and/or remote communication, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a vehicle's electronic control unit (ECU) (e.g., client electronic device 140, which may encompass some or all of the electronic controls (e.g., microprocessor-controlled units) in a vehicle, managing a wide array of functions, from engine operation and fuel efficiency to handling braking systems (ABS), airbag deployment, infotainment systems, transmission systems, climate control, fuel cell operation, radiator systems, etc.), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of AG process 110 (and vice versa). Accordingly, in some implementations, AG process 110 may be a purely server-side application, a purely client-side application, or a hybrid server-side/client-side application that is cooperatively executed by one or more of client applications 122, 124, 126, 128 and/or AG process 110.

In some implementations, one or more of client applications 122, 124, 126, 128 may be configured to effectuate some or all of the functionality of infotainment application 120 (and vice versa). Accordingly, in some implementations, infotainment application 120 may be a purely server-side application, a purely client-side application, or a hybrid server-side/client-side application that is cooperatively executed by one or more of client applications 122, 124, 126, 128 and/or infotainment application 120. As one or more of client applications 122, 124, 126, 128, AG process 110, and infotainment application 120, taken singly or in any combination, may effectuate some or all of the same functionality, any description of effectuating such functionality via one or more of client applications 122, 124, 126, 128, AG process 110, infotainment application 120, or combination thereof, and any described interaction(s) between one or more of client applications 122, 124, 126, 128, AG process 110, infotainment application 120, or combination thereof to effectuate such functionality, should be taken as an example only and not to limit the scope of the disclosure.

In some implementations, one or more of users 146, 148, 150, 152 may access computer 112 and AG process 110 (e.g., using one or more of client electronic devices 138, 140, 142, 144) directly through network 114 or through network 118. Further, computer 112 may be connected to network 114 through network 118, as illustrated with phantom link line 154. AG process 110 may include one or more user interfaces, such as browsers and textual or graphical user interfaces, through which users 146, 148, 150, 152 may access AG process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

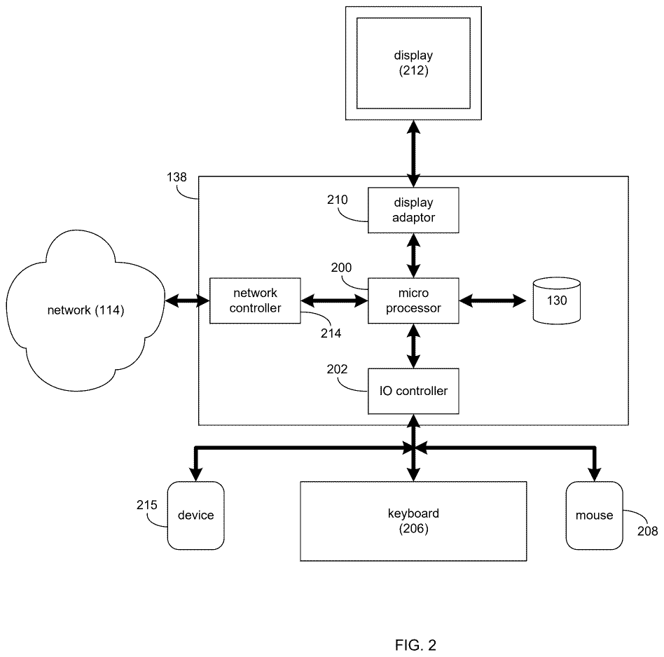

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, AG process 110 may be substituted for client electronic device 138 (in whole or in part) within FIG. 2, examples of which may include but are not limited to computer 112 and/or one or more of client electronic devices 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

Vehicle dashboards are generally composed of class A surfaces (i.e., continuous surfaces having curvature and tangency alignment) for aesthetical purposes. While ensuring good aesthetic quality of reflections under different ambient lights, these dashboards often disturb and impair the driver's forward vision when exposed to direct sunlight. Moreover, when a part of a reflective dashboard is reflected into the windshield, the veiling glare (also known as a “ghost images” effect) can occur, decreasing the visibility of the objects ahead on the road, causing a safety hazard.

To address this problem, some users may use third-party solutions, such as texturized dashboard mats that are made of synthetic (e.g., PU leather) or natural (e.g., felt, cotton) materials. Although reducing the glare related issues by using texturized surfaces, these third-party mats negatively affect the interior design aesthetics by compromising the dashboard surface qualities (e.g., it is always texturized even when there is no direct sunlight or resulting glare related issues, and it may shrink or deform after prolonged use, etc.).

Therefore, as will be discussed in greater detail below, the present disclosure addresses these example and non-limiting issues of glare/reflection issues without negatively affecting the dashboard surface qualities or aesthetics. A multi-layered, thin and stretchable fabric-based composite surface is disclosed that may be seamlessly attached to the dashboard. This thin and initially flat composite surface may include a 4-way stretchable fabric and an array of liquid crystal elastomer (LCE) unit cells, each of which may transform from flat to a predefined targeted 3D shapes when exposed to some stimuli (e.g., ambient stimuli, such as heat or light), generating a temporarily protruded surface which potentially diffuses the light rays and reduces the overall glare/reflection. In some implementations, each LCE unit cell may be laminated under the stretchable fabric, therefore, not interfering with the dashboard's surface continuity when not in use.

Example and non-limiting advantages and improvements over some current solutions may include, e.g.,: a lightweight and scalable design; a very low system design cost (e.g., natural UV powered so no operation cost, no need for microcontrollers, sensors, cables, or any other auxiliary system components); easily conforms to differently shaped surfaces without affecting surface continuity; passively deploys and stows as a function of sunlight exposure, making it adaptive; and not compromising dashboard aesthetical qualities when not in use, remaining hidden.

### The AG Process

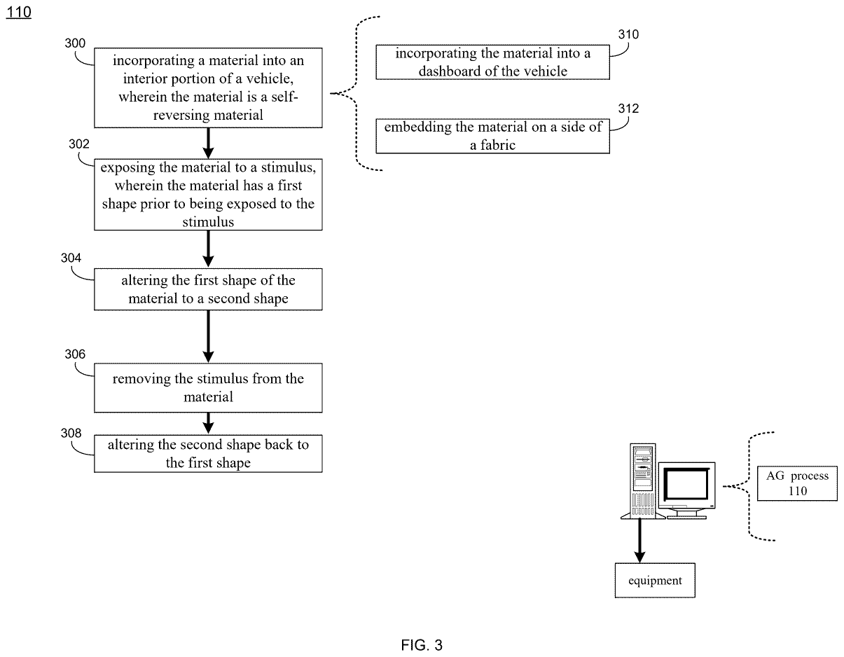

As discussed above and referring also at least to the example implementations of FIGS. 3-6, AG process 110 may incorporate 300 a material into an interior portion of a vehicle, wherein the material is a self-reversing material. AG process 110 may expose 302 the material to a stimulus, wherein the material has a first shape prior to being exposed to the stimulus. AG process 110 may alter 306 the first shape of the material to a second shape based upon, at least in part, exposing the material to the stimulus. AG process 110 may remove 308 the stimulus from the material. AG process 110 may alter 308 the second shape back to the first shape based upon, at least in part, removing the stimulus from the material.

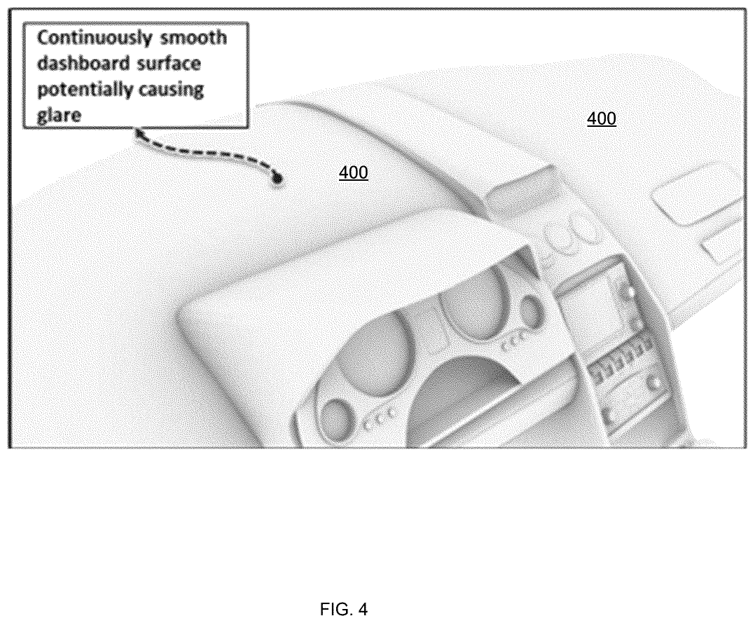

In some implementations, AG process 110 may incorporate 300 a material into an interior portion of a vehicle, wherein the material is a self-reversing material (described further below). For example, in some implementations, incorporating the material into the interior portion of the vehicle may include incorporating 310 the material into a dashboard of the vehicle. For instance, and referring at least to the example implementation of FIG. 4, an example vehicle dashboard (e.g., dashboard 400) is shown. The vehicle may be any type of vehicle (e.g., car, truck, motorcycle, aerial vehicle, etc.). As can be seen from FIG. 4, dashboard 400 has a continuously smooth surface, which may cause glare (e.g., on the windshield) as discussed above. To help reduce or even potentially eliminate such a glare, the material incorporated into dashboard 400 may include a self-reversing material, which may generally be described as a type of smart material that can return to its original shape or state after undergoing a transformation in response to an external stimulus. An example of a self-reversing material may include one or more liquid crystal elastomer (LCE) unit cells. As understood by those skilled in the art, an LCE unit cell is the smallest repeating structural component the arrays of which compose the morphing anti-glare surface system.

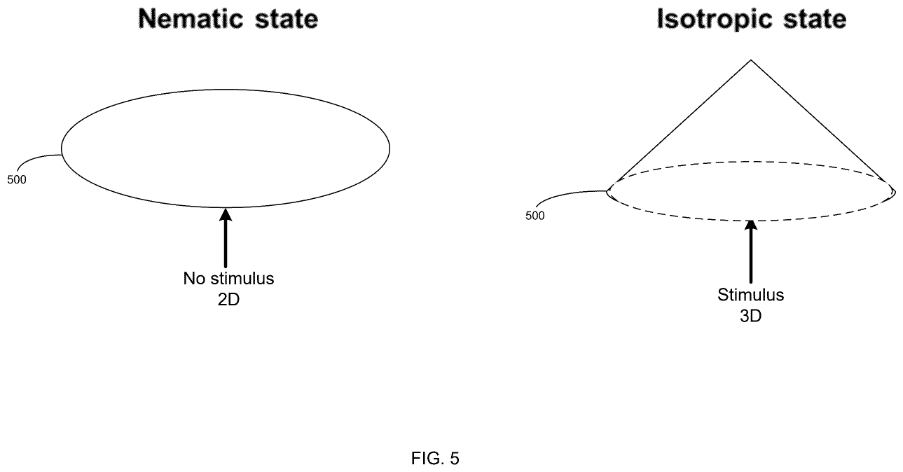

For instance, and referring to the example implementation of FIG. 5, an example LCE unit cell (e.g., LCE unit cell 500) is shown. LCEs may generally be described as a type of smart material that uniquely combines the properties of liquid crystals and elastomers, which are polymers with elastic characteristics. Liquid crystals have an intermediate state between conventional liquids and solid crystals, where their molecules are oriented in a specific direction like a solid but can still flow like a liquid. Elastomers, on the other hand, are materials that exhibit elasticity, meaning they can stretch or deform and then return to their original shape. When these two materials are combined, LCEs demonstrate an ability to change shape in response to external stimuli such as heat, light, an electric field, or combination thereof.

The shape-changing ability of LCE unit cells, known as actuation, occurs when the ordered liquid crystal molecules within the elastomer matrix respond to an external stimulus. For instance, when a stimulus, such as heat or light (e.g., Ultra Violet (UV) light from the sun), is applied, the liquid crystal molecules reorient or change their phase, causing the elastomer matrix to stretch, contract, bend, or twist. This molecular reorientation results in a macroscopic shape change in the material. For example, as shown in FIG. 5, the LCE is flat (in the nematic state) without the stimulus, and cone shaped (in the isotropic state) when the stimulus is applied. It will be appreciated that various other starting and ending shapes may be used. For example, an LCE unit cell might curl or expand in response to the stimulus. Once the stimulus is removed, the material typically reverts to its original shape. In some implementations, the specific stimuli that can induce these changes may include temperature, where heating the LCE causes a phase transition in the liquid crystal molecules, light (e.g., UV light), where photo-responsive LCEs change shape due to light-sensitive molecules, and electric or magnetic fields, which induce reorientation of the liquid crystal molecules.

It will be appreciated that the use of a LCE unit cell is for ease of discussion, and that any type of self-reversing material may be used. That is, any type of material that is self-reversing where it is one shape before being exposed to a stimulus, another shape after being exposed to the stimulus (or combination of stimuli), and goes back to the first shape after being removed from the stimulus, may be used without departing from the scope of the present disclosure. For example, other smart materials that may exhibit similar shape-changing properties may include, e.g., Shape Memory Alloys (SMAs), such as nitinol, Shape Memory Polymers (SMPs), hydrogels (capable of swelling or shrinking in response to environmental changes), piezoelectric materials that can deform when an electric field is applied, magnetostrictive materials, etc. As such, the use of LCE unit cells should be taken as example only and not to otherwise limit the scope of the present disclosure.

In some implementations, incorporating the material into the interior portion of the vehicle may include embedding 312 the material on a side of a fabric. For instance, embedding LCEs on the side of a fabric (e.g., a four-way stretchable fabric) may involve integrating the LCE material into the fabric's structure in a way that maintains its ability to respond to stimuli while ensuring flexibility and durability. One example approach is to coat the fabric with a thin layer of LCE material by dissolving the LCE in a suitable solvent and applying it through, e.g., dip-coating, spray-coating, or blade spreading. After the solvent evaporates, a uniform LCE layer remains adhered to the fabric. In some implementations, a thin film of LCE may be produced separately through casting or extrusion and then laminated onto the fabric using adhesives or heat pressing, providing controlled thickness and uniformity. Direct printing or extrusion methods, such as 3D printing, allow for precise placement of LCE on the fabric, enabling localized actuation. LCEs can also be incorporated as fibers spun and woven or knitted into the fabric, offering deeper integration within the fabric's structure for enhanced flexibility and durability. In some implementations, microencapsulation may be used, where microcapsules containing LCEs are embedded within the fabric. These microcapsules may activate under similar stimuli discussed throughout, inducing localized shape changes for a dynamic response. In some implementations, a hybrid approach combining these methods may be used, such as laminating LCE films on specific sections while weaving LCE fibers into others, creating a fabric with tailored properties.

As noted above, the fabric may be a four-way stretchable fabric. A four-way stretchable fabric may generally be described as a type of textile that can stretch both horizontally and vertically, providing flexibility in all directions. This means the fabric can extend and recover its shape along both the width (side-to-side) and the length (up-and-down), making it highly adaptable. The fabric's elasticity may be achieved by, e.g., incorporating elastomeric fibers, such as spandex, Lycra, or elastane, into the weave or knit of the fabric. These fibers allow the material to stretch significantly without losing its shape or structural integrity.

In some implementations, the LCEs may be incorporated into something portable (e.g., such as a mat) that the user can simply drape over their dashboard. This may be beneficial for vehicles that were not already manufactured with the LCEs embedded in the dashboard. As such, the description of LCEs being incorporated into a vehicle's dashboard should be taken as example only and not to otherwise limit the scope of the present disclosure.

In some implementations, AG process 110 may expose 302 the material to a stimulus, wherein the material has a first shape prior to being exposed to the stimulus (e.g., UV light). For instance, as noted above with regard to FIG. 5, there is shown LCE unit cell 500 transforming from a flat 2D state to a deployed (cone) 3D state as a function of UV light presence and intensity. In some implementations, an array of LCE unit cells transforming from the flat to the deployed states may be used, which may be in physical contact, but this is not required, particularly when the LCEs are embedded on a stretchable fabric surface, where they can be placed apart from one another.

The use of a UV light stimulus may have certain advantages, as this would be a naturally occurring stimulus from the sun, which would cause the shape change when the sun may cause glare, generating a temporarily protruded surface which potentially diffuses the light rays and reduces the overall glare/reflection. This would also eliminate the need for operational costs, such as microcontrollers, sensors, cables, or any other auxiliary system components. However, it will be appreciated after reading the present disclosure that the stimulus may include heat or a combination of stimuli. In some implementations, heating sources (e.g., coils) may be placed underneath dashboard 400, which may be controlled by the user similar to how the user controls the climate within the vehicle's interior (e.g., using knobs or other type of temperature user interface (UI) that may be operated by the vehicle's ECU). This may enable the user to have more personalized control for which zones on the dashboard may be affected (e.g., just the left side or the right side), as well as how much stimulus is applied, as the change in shape may be proportional to the amount of stimulus applied. In a similar regard, the stimulus may be an electromagnetic field controllable by the user. As a result of enabling the user to control the stimuli, the user may be able to increase (or decrease) the effect of the LCE unit cell's shape change should that be desired (e.g., increase the shape change to further reduce glare or turn the feature off altogether).

In some implementations, the intensity of the shape change in the LCE unit cells may be configured and controlled through several factors during the material's design and fabrication process. The alignment of liquid crystal molecules is a factor, as the degree of molecular alignment, which can be controlled during fabrication through methods such as mechanical stretching, electric fields, or surface treatments, directly influences the magnitude and direction of the shape change. Additionally, the crosslinking density within the elastomer matrix, which refers to the number of crosslinks between polymer chains, plays a role; a higher crosslinking density results in a stiffer material with less pronounced shape changes, while a lower density allows for more substantial deformations. The choice of liquid crystal type, such as nematic, smectic, or cholesteric, also affects the LCE's responsiveness, with different liquid crystals exhibiting varying degrees of shape change.

Moreover, the degree of pre-strain applied to the LCE material before use can set a baseline deformation level, thereby influencing how much the material will expand, contract, or bend upon stimulus application. The nature and intensity of the stimulus itself, whether it be temperature, light, or an electric field, also may determine the shape change, with stronger stimuli generally inducing more significant changes. Additionally, by layering LCEs with different properties or combining them with other materials, composite structures can be created, allowing for complex and customizable actuation behaviors. Through careful material engineering and design, the intensity of the shape change in LCE unit cells can be finely tuned to meet specific application requirements, making these materials highly versatile in various smart material applications.

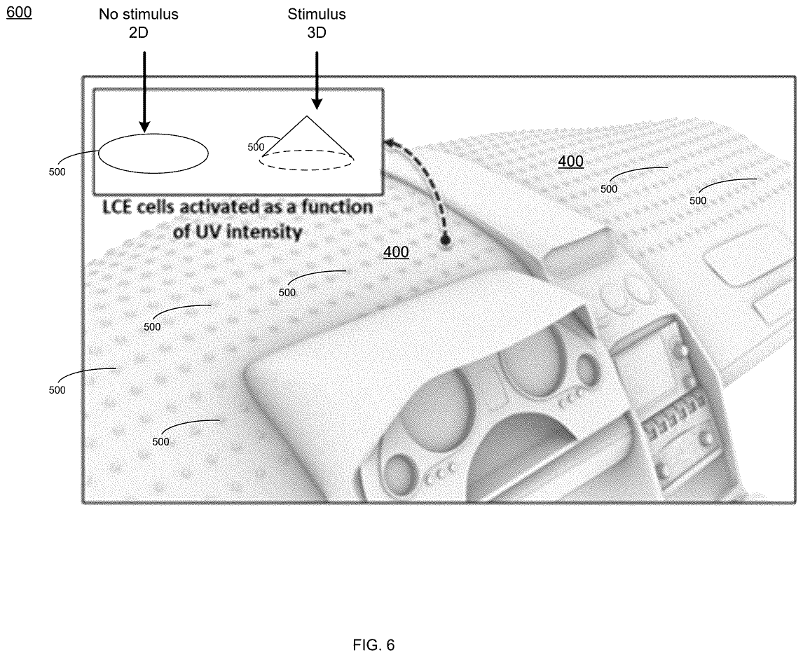

Thus, in some implementations, AG process 110 may alter 306 the first shape of the material to a second shape based upon, at least in part, exposing the material to the stimulus, AG process 110 may remove 308 the stimulus from the material (e.g., either naturally or using the vehicles ECU to control the stimulus), and may alter 308 the second shape back to the first shape based upon, at least in part, removing the stimulus from the material. For instance, and referring at least to the example implementation of FIG. 6, an diagrammatic view 600 of an example dashboard (i.e., dashboard 400 of FIG. 4) now with the LCEs activated is shown. In the example, each LCE unit cell composing the distributed array underneath the dashboard (or a separate stretchable fabric) can be activated when exposed to UV light (or other stimulus), resulting in transforming from flat state to 3D deployed state (e.g., cone shape). As a result of the passive LCE unit cell deployment, the dashboard surface temporarily becomes protruded/texturized, which reduces/eliminates the potential sunlight reflections and veiling glare on the windshield. When the stimulus is removed (e.g., the intensity of the UV light has sufficiently decreased past a threshold amount), the LCE unit cells may revert back to their flat state. That is, in an example when there might be no direct sunlight shining on the dashboard, the deployed portion of the LCE unit cell array transforms back to its flat state, following the original contour of the dashboard design. The overall pattern and transitioning motion (from flat to deployed and vice versa) generated by the adaptive array of LCE unit cells can be aesthetically pleasing.

It will be appreciated after reading the present disclosure that any standard assembly/printing/fabrication, etc. equipment, as well as any other necessary equipment, and any particular location, such as at a foundry, fabrication facility, etc. may be used singly or in any combination with AG process 110, which may be operatively connected to a computing device, such as the computing device shown in FIG. 3, to obtain their instructions for creating and/or executing one or more aspects of the present disclosure. In one or more example implementations, the respective flowcharts may be manually implemented, computer-implemented, or a combination thereof.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method of using a stimulus-based self-reversing material comprising:
incorporating a material into an interior portion of a vehicle, wherein the material is a self-reversing material;
exposing the material to a stimulus, wherein the material has a first shape prior to being exposed to the stimulus;
altering the first shape of the material to a second shape based upon, at least in part, exposing the material to the stimulus;
removing the stimulus from the material; and
altering the second shape back to the first shape based upon, at least in part, removing the stimulus from the material.

2. The method of claim 1, wherein the material includes a plurality of liquid crystal elastomer unit cells.

3. The method of claim 1, wherein the stimulus is ultraviolet light.

4. The method of claim 1, wherein the stimulus is heat.

5. The method of claim 1, wherein incorporating the material into the interior portion of the vehicle includes incorporating the material into a dashboard of the vehicle.

6. The method of claim 1, wherein incorporating the material into the interior portion of the vehicle includes embedding the material on a side of a fabric.

7. The method of claim 6, wherein the fabric is a four-way stretchable fabric.

8. A stimulus-based self-reversing material comprising:
a material incorporated into an interior portion of a vehicle, wherein the material is a self-reversing material, wherein the material has a first shape prior to being exposed to a stimulus, wherein the first shape of the material is altered to a second shape based upon, at least in part, exposure of the material to the stimulus, wherein the second shape is altered back to the first shape based upon, at least in part, removing the stimulus from the material.

9. The stimulus-based self-reversing material of claim 8, wherein the material includes a plurality of liquid crystal elastomer unit cells.

10. The stimulus-based self-reversing material of claim 8, wherein the stimulus is ultraviolet light.

11. The stimulus-based self-reversing material of claim 8, wherein the stimulus is heat.

12. The stimulus-based self-reversing material of claim 8, wherein the material is incorporated into a dashboard of the vehicle.

13. The stimulus-based self-reversing material of claim 8, wherein the material is embedded on a side of a fabric.

14. The stimulus-based self-reversing material of claim 13, wherein the fabric is a four-way stretchable fabric.

15. A computer program product residing on a computer readable storage medium having a plurality of instructions stored thereon which, when executed across one or more processors, causes at least a portion of the one or more processors to perform operations comprising:
incorporating a material into an interior portion of a vehicle, wherein the material is a self-reversing material;
exposing the material to a stimulus, wherein the material has a first shape prior to being exposed to the stimulus;
altering the first shape of the material to a second shape based upon, at least in part, exposing the material to the stimulus;
removing the stimulus from the material; and
altering the second shape back to the first shape based upon, at least in part, removing the stimulus from the material.

16. The computer program product of claim 15, wherein the self-reversing material includes a plurality of liquid crystal elastomer unit cells.

17. The computer program product of claim 15, wherein the stimulus is ultraviolet light.

18. The computer program product of claim 15, wherein the stimulus is heat.

19. The computer program product of claim 15, wherein incorporating the material into the interior portion of the vehicle includes incorporating the material into a dashboard of the vehicle.

20. The computer program product of claim 15, wherein incorporating the material into the interior portion of the vehicle includes embedding the material on a side of a four-way stretchable fabric.
